(19) United States
(12) Patent Application Publication
(10) Pub. No.: US 2016/0154021 A1
(43) Pub. Date: Jun. 2, 2016

(54) CALCULATION OF ACCELERATION BASED ON SPEED MEASUREMENT

(71) Applicant: MOVELO AB, Djursholm (SE)

(72) Inventors: ISAAC SKOG, Stockholm (SE); PETER Händel, Stockholm (SE); Martin OHLSSON, Täby (SE); Jens OHLSSON, Stocksund (SE)

(21) Appl. No.: 14/901,335

(22) PCT Filed: Jun. 26, 2014
(86) PCT No.: PCT/SE2014/050791

§ 371 Date: Dec. 28, 2015

(30) Foreign Application Priority Data
Jun. 28, 2013 (SE) 1330082-7

(51) Int. Cl. G01P 15/16

(52) U.S. Cl. CPC G01P 15/16

(57) ABSTRACT

A method for calculation, with high time resolution, of acceleration of an object in motion from a measurement, with low time resolution, of speed of the object, comprises approximation of the speed of the object from the speed measurement and a parametric model describing the motion of the object. The method further comprises estimation of parameters in the parametric model through a parametric estimation method based on the speed measurement and the parametric model. The method also comprises calculation of acceleration of the object from the parametric model and the estimated parameters, and calculation of a quality index representing the quality of the calculated acceleration from a quality measure representing the adaptation of the parametric model to the speed measurement, and a quality measure representing the quality of the speed measurement.

### TECHNICAL FIELD

The present invention relates to a device for calculation, with high time resolution, of acceleration of an object in motion from a speed measurement with low time resolution with associated quality measure of speed measurement; comprising means for estimation of current speed with a parametric model describing the dynamics of the motion; means for calculating an acceleration from the parametric model; means for calculating a quality index for said calculated acceleration from calculated quality of said parametric model and said quality measure of said speed measurement.

### BACKGROUND

The introduction of so-called Smartphones such as iPhone and Android-based phones such as for example HTC Desire has increased the availability of the information technology—the functionality of the mobile phone has been multiplied from being a device for voice calls, to a device with a versatile field of application. Other devices with overlapping functionality comprise for example palm-pilots, tablets such as iPad and Android-based tablets such as Samsung Galaxy Tab P1000, notebooks, PC laptops or other general portable computer products where the functionality for the user may be adapted by downloading of computer programs from electronic market places such as App Store or Android Market or computer-readable media such as CD, DVD, USB-memory, hard drive, etc. The invention applies to personal electronics such as exemplified above, which for simplicity are given the collective name mobile phone, and in particular when this personal electronics is used in a motor vehicle during travel.

Modern mobile phones often have built-in receivers for satellite navigation systems. Several satellite navigation systems are in use such as for example GPS (United States NAVSTAR Global Positioning System), GLONASS (Russian Global Navigation Satellite System), Galileo (Europe), COMPASS (China)—which are gathered under the collective name GNSS (Global Navigation Satellite System). An example of GNSS with support from local positioning with the aid of the mobile phone systems is assisted GPS (A-GPS). In particular GPS of the different GNSS-systems has had a major impact and GPS receivers are nowadays found in a majority of mobile phones, in a great majority they have support for A-GPS. Also GLONASS is common nowadays.

The GNSS systems deliver information on current speed, position, direction of travel (heading), time, with associated quality measures through standardized protocols such as NMEA 0183 or through vendor-specific protocols; Trimble Standard Interface Protocol and SiRF Binary Protocol are two examples. Data from GNSS receivers are used in a variety of applications, for example car navigation systems, maritime navigation systems, traffic flow measurements, drivers log systems and fleet management. Data from GNSS receivers are also used for determining position for location-based services and functionality such as marking of digital photographs, location-based search services for market offerings, timetables and route lists, news services.

The vast majority of mobile phones with built-in GNSS receivers deliver data with 1 second intervals, i.e. 1 Hertz update rate. This is enough for the applications exemplified above, and is a result of demands for energy efficiency and cost efficiency that exist on this class of products.

Despite the above-mentioned limitation in data update rate, there is a need for using mobile phones for other applications than the applications they are originally intended for. Such an example is for detection of rapid speed changes. Rapid speed changes occur for example when a car driver performs heavy braking for the purpose of stopping the vehicle. Precisely detection of heavy braking may be used as a risk parameter when calculating an insurance premium for a vehicle based on driving behavior. A driver with a large number of braking maneuvers, measured over driving time or driving distance, may indicate a higher risk factor than a driver with a lower number of heavy braking maneuvers.

A car insurance premium for private cars is traditionally based on the classification of the vehicle owner and the vehicle in terms of vehicle type, driving distance, age, gender, geographical residence and number of damage-free years. These are by necessity blunt instruments for determining an insurance premium. For an expert it is obvious that similar calculation rules apply to other types of motor vehicles such as buses and trucks.

Premium calculation based on actual driving behaviour is on the market, for example the insurance company If's SafeDrive. Through active monitoring of the vehicle by technical equipment a premium may be calculated not only from the above-mentioned list of criteria, but also from for example
time of day when the vehicle is driven, which is registered by storing and processing of time stamps,
driving distance, which is obtained by summation of position differences,
speed,
strong acceleration, retardation or evasive maneuvers, where for example heavy braking is detected when the retardation exceeds a threshold value. In particular the absence of heavy braking indicates a safe driving style which may render a discount of the insurance premium,
violent changes in direction of travel.

The mentioned technical equipment may be fixedly installed, or consist of a modern mobile phone, since a modern mobile phone is not only equipped with GNSS receivers but also with sensors such as accelerometer and gyro. If's SafeDrive is available as an app (computer program) for iPhone.

The invention is related to detection of strong acceleration and retardation. These are normally detected by means of an accelerometer which thus may be fixedly mounted in the vehicle, alternatively an accelerometer in a mobile phone which in turn is fixedly mounted in the vehicle in a holding device intended for the purpose. Fixed mounting is necessary since an accelerometer cannot separate the true acceleration of the vehicle from the force of the Earth's gravity. In order to accurately measure the acceleration of the vehicle by means of a fixedly mounted accelerometer the angle between the sensitivity axis of the accelerometer and the direction of the Earth's acceleration must be known with an accuracy of a few degrees.

Today most new mobile phones are equipped with Micro-Electro-Mechanical System (MEMS) accelerometers which in theory may be used for detection of strong acceleration and retardation of a vehicle. From now on we settle for talking about heavy braking, since it is obvious that this is an acceleration. These sensors have an update rate of 30-100 updates per second (30-100 Hertz) which is sufficient resolution for said problem. A large obstacle for using the built-in accelerometer in the mobile phone for said problem is that the mobile phone at normal operation and use continuously changes position in the car and that it is therefore complicated and computationally demanding to continuously calculate the angle between the sensitivity axes of the accelerometers in the mobile phone and the gravitational vector. It is also necessary that such a calculation has access to supplementary information, such as speed from GNSS receivers. To compensate the measurements from the accelerometers in the mobile phone for influence from the Earth's gravity thus requires a considerable computational power, which results in that the battery life is significantly shortened.

### SUMMARY

The invention relates to a method, device or program for calculating a high resolution acceleration signal from a low resolution measurement of speed. The invention further relates to a method, device or program for calculating a quality index associated with said acceleration signal.

The invention further relates to a method, device or program for detecting strong acceleration or retardation from said calculated acceleration signal and quality index.

These methods are achieved by parametric modelling of the dynamics of said speed measurement; means for calculating an acceleration from the parametric model; means for calculating a quality index for said calculated acceleration from calculated quality of said parametric model and said quality measure of said speed measurement.

### BRIEF DESCRIPTION OF DRAWINGS

The invention will be described in more detail in the following with reference to the attached drawings, which illustrate examples of selected embodiments, where:

FIG. 1 shows a simple configuration with a signal processing device, a GNSS receiver, and a personal computer for visualization of the signal processing,

FIG. 2 shows an example of a visualized display in accordance with FIG. 1,

FIG. 3 shows a flow diagram for an acceleration determination in accordance with this invention,

FIG. 4 shows a time diagram in accordance with this invention,

FIG. 5, shows a flow diagram for detection of heavy braking in accordance with this invention,

FIG. 6 shows an example of speed signal from GNSS receiver and resulting acceleration signal and quality index from a circuit diagram of an embodiment of signal processing in a accordance with the invention,

FIG. 7, shows an example of the distribution in sampling interval for GNSS data from an iPhone 5.

### DETAILED DESCRIPTION

Throughout the drawings the same reference numbers are used for similar or corresponding elements.

The proposed invention overcomes difficulties mentioned in the background by replacing the accelerometer (with update rate 30-100 Hertz) as a sensor by only a GNSS receiver (with update rate 1 Hertz), where the accelerometer's direct measurement of acceleration is replaced by an indirect measurement of acceleration through measured speed in combination with a parametric model or description of the motion. The challenge with this approach is multiple, including choice of parametric model and to reliably estimate the parameters in the parametric model in the presence of discontinuities and divergent values in measurement data. It is well known that speed data from a GNSS receiver contains isolated measurement points of poor quality, and periods of poor measurement data due to poor coverage.

It is not known to the inventors any electronic aid where an acceleration signal of high update rate is calculated from a speed signal with low update rate from a GNSS receiver, which at the same time ensures the validity of the calculated acceleration signal through a calculated quality index which depends on the quality of the original speed signal in combination with the quality of the parametric model that is used for describing the dynamics of the motion. Further, it is not known how such a quality index together with a calculated acceleration signal may be used to detect heavy braking of a vehicle during travel in a robust manner.

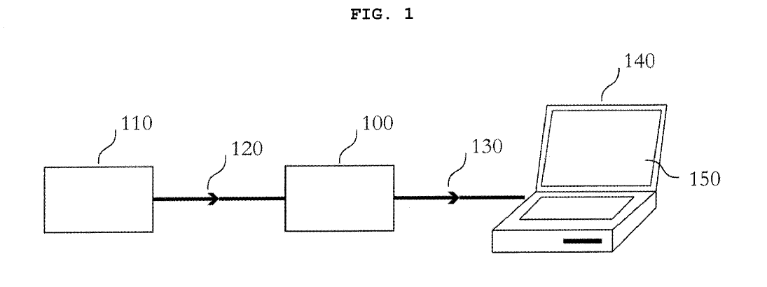

FIG. 1 shows a simple design with a signal processing device 100 and a GNSS receiver 110. GNSS receiver 110 is connected to signal processing device 100 through a signaling cable 120. This connection 120 implies in particular a possibility for communication between receiver 110 and device 100 for transfer of sensor data to device 100. The result of the signal processing in device 100 is sent through the signaling cable 130 to a personal computer 140. In the personal computer 140 there is a program installed which enables visualization of calculated acceleration and associated quality index on the screen 150 of the computer. To the skilled person it is obvious that GNSS receiver 110 may be connected directly to personal computer 140 through a signaling cable 120 and that device 100 is replaced with a computer program product with program elements for combined signal processing and presentation. Data through signaling cable 120 may be communicated through standard protocols such as RS232 and USB. Signaling cable 120 may also be replaced with wireless communication through WiFi, Bluetooth, infrared (IR), or similar. GNSS receiver may also be built into personal computer 140, which nowadays is common for portable computers, in which case signaling cable comprises the personal computer's architecture for internal data communication. It is obvious that personal computer 140 also comprises other personal electronics that previously has been exemplified under the collective name mobile phone.

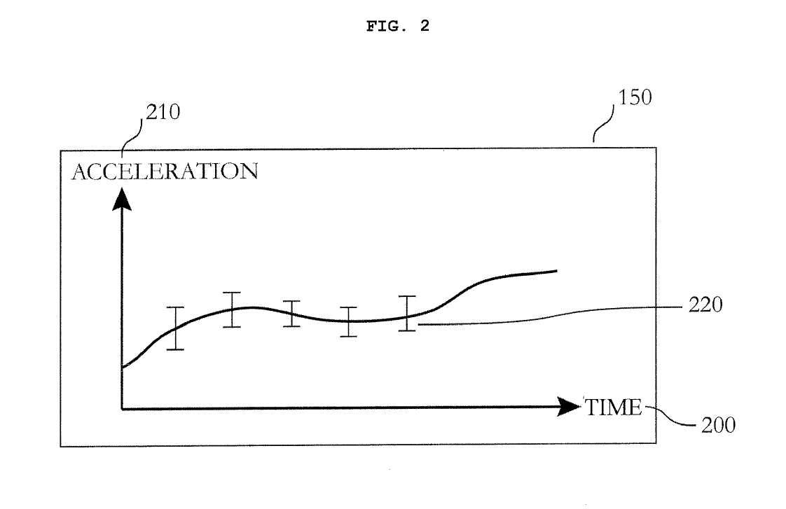

FIG. 2 shows an example of a visualizing display in accordance with FIG. 1. The display 150 visualizes on the y-axis 210 how the acceleration changes with time along the x-axis 200. Also the quality index associated with the acceleration signal is illustrated through the confidence intervals 220, where the size of the confidence intervals indicates the quality of data.

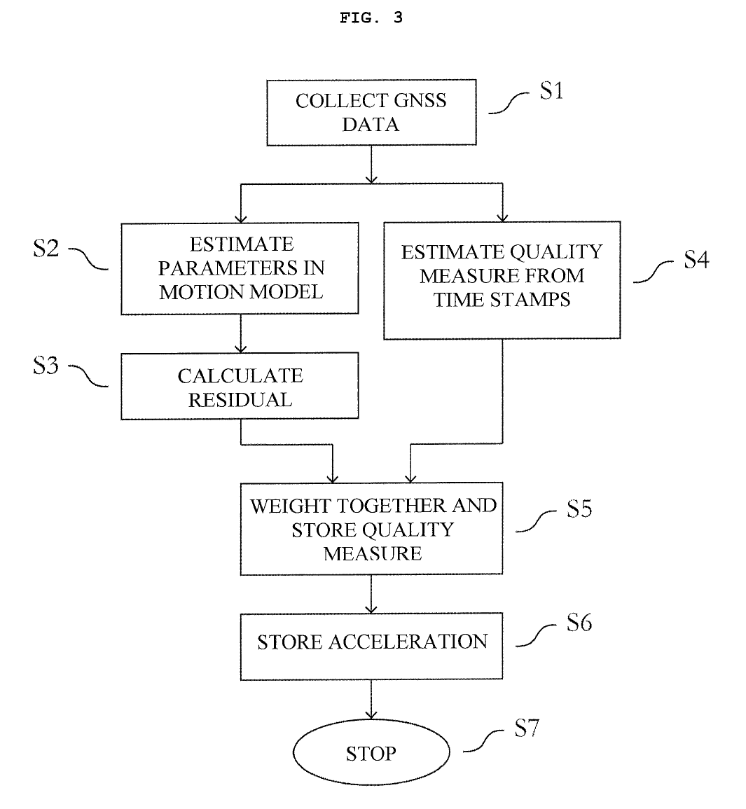

FIG. 3 shows a flow diagram for a method according to the proposed invention. In step S1 data is collected from the GNSS receiver as a sequence and saved in data blocks. The method visualized in FIG. 3 calculates the acceleration for a time corresponding to the time for one of the measured values in the block with data corresponding to a time tₖ. Due to symmetry it is natural to select the data block so that it is centered around the time tₖ with an equal amount of data points (say N of them) in the block present before as after the time tₖ, that is data corresponding to the times {t_{k-N}, . . . , tₖ, . . . , t_{k+N}}, that is a data block of length 2N+1, where N is an integer. To the skilled person it is obvious that the method is just as applicable for data blocks where tₖ is not centered in the block, for example by using more historical values compared to future values, and vice versa.

For each time tₖ the three data blocks times {t_{k-N}, . . . , tₖ . . . , t_{k+N}}, speed measurements (in the direction of the motion) {v_{k-N}, . . . , vₖ . . . , v_{k+N}}, and quality measure {q_{k-N}, . . . , qₖ, . . . , q_{k+N}} are saved, where vₖ and qₖ symbolize the speed and data quality provided by the GNSS receiver at time tₖ.

After step S1 the diagram is divided into two branches, step S2 and S4 respectively. It is obvious to the expert that since these different branches are independent from each other, the execution may also be done sequentially.

In step S2 a parametric motion model sₖ(θ, t) is adapted to the speed data collected in step S1. The parametric motion model sₖ(θ, t), which is unequivocally described by the parameters (the number of free parameters is L+1) θ={α₀, α₁, . . . , α_{L}}, may be a linear function, non-linear function, discontinuous function that describes a relationship between times and parameters to speed. In a preferred embodiment of the invention the motion model is a polynomial of order L, where L=0, 1, 2, 3, . . . . In a preferred embodiment of the invention the motion model is a second order polynomial, i.e. sₖ(θ, t)=α₀+α₁(t−tₖ)+α₂(t−tₖ)², which exemplifies a linear function in the parameters θ={α₀, α₁, α₂}. Thus in step S2 an adjustment of the parameters θ={α₀α₁, . . . , α_{L}} is done so that the output signal from the model sₖ(θ, t) fits as closely as possible to collected speed data {v_{k-N}, . . . , vₖ . . . , v_{k+N}}, resulting in numeric values which are denoted \hat{θ}ₖ where index k indicates that it is that parameter set which is applicable to the speed block centered around tₖ, {v_{k-N}, . . . , vₖ . . . , v_{k+N}}. Adaptation of the parameters in the motion model is done at each time tₖ based on surrounding data. Mathematically adaptation can be done by minimizing a cost function Vₖ(θ), i.e. \hat{θ}ₖ=argmin_{θ}Vₖ(θ) where the cost function is a function of the difference between the measured value of the speed and the model's predicted speed as a function of the searched parameters, based on the measured values in the current block of data. The cost function may for example be a sum of squares of the errors, weighted sum of squares of the errors, maximum absolute value of the error or such that it maximizes the probability for the observed data (maximum likelihood) (which can be solved as a minimizing problem to fit into the framework of minimizing a cost function). To the skilled person it is obvious that measurement data in the cost function can be weighted with the quality measures {q_{k-N}, . . . , qₖ, . . . , q_{k+N}} to minimize the influence of measured values with high uncertainty in the model adaptation. In a proposed design of the invention a weighted sum of squares of the mathematical terms Vₖ(θ)=Σₗ₌ₖ^{k+N} wₗ(vₗ−sₖ(θ, tₗ))²=Σ_{l=k-N}^{k+N} wₗ(v₁−(α₀+α₁(tₗ−tₖ)+α₂(tₗ−tₖ)²))² where the second equality exemplifies the use of a second order polynomial, where the weights are suitable positive real numbers, for example forming a parabola where data close to the end points of the data block is weighted down for the benefit of a higher weight closer to the midpoint of the block. The solution is given in the example with a second order polynomial of the parameters {α₀, α₁, α₂} which minimize the cost function.

In step S3 a residual or rest term is then calculated which describes the adaptation between model and measurement data. The residual is a scalar value which for example is given by the minimum value Vₖ(\hat{θ}ₖ) of the cost function or other above mentioned function of the error.

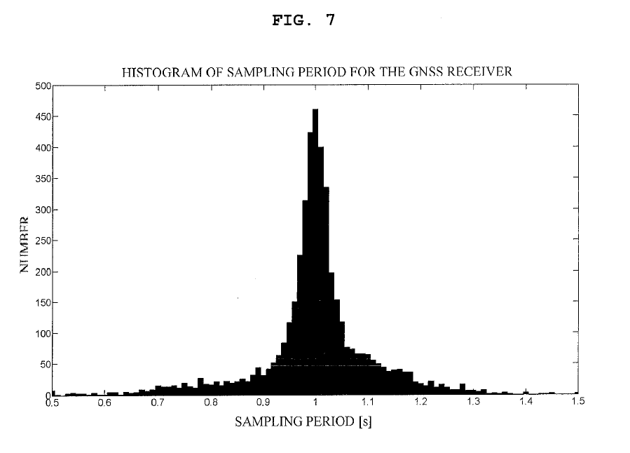

In step S4 a quality measure qₖ^{t}, is calculated for data based on the sampling times {t_{k-N}, . . . , tₖ, . . . , t_{k+N}}. The mapping qₖ^{t}←({t_{k-N}, . . . , tₖ, . . . , t_{K+N}}) can be done in several ways, for example by comparing the sampling intervals {t_{k+N}−t_{k+N-1}, . . . , t_{k-N+1}−t_{k-N}} with the nominal sampling period of GNSS receivers. At normal operational circumstances and at favorable receiving circumstances a GNSS receiver in a mobile phone typically has a sampling period tₖ−tₖ₋₁=1 second. If the sampling period of the GNSS receiver varies greatly it is an indicator that the GNSS receiver is having trouble calculating its position and speed, and measurement data is therefore typically of low quality. Examples of actual sampling periods for GNSS data during travel in a vehicle collected with an iPhone 5 is illustrated in FIG. 7 from which it is apparent that the distribution around the ideal 1-second interval in many cases may be large. In a proposed design of the invention a mapping of the form

$${q}_{k}^{t} = \frac{1}{N} {\sum }_{l = k - N + 1}^{k + N} {( ( {t}_{l} - {t}_{l - 1} ) - T )}^{2}$$

is used where typically T=1 second.

In step S5 a partial quality index δqₖ^{tot} is calculated for data at time tₖ by weighting together the residual (for example Vₖ(\hat{θ}ₖ), the quality measure qₖ of the GNSS receiver and the in the step S4 calculated quality measure qₖ^{t}. It is obvious that these quality measures can be weighted together in several ways, where different weights are given to the different included quality measures. In a proposed embodiment we weight the quality measures together according to δqₖ^{tot}=β₀Vₖ(\hat{θ}ₖ)+β₁qₖ+β₂qₖ^{t}, where Vₖ(\hat{θ}ₖ) is a residual, and β₀, β₁, β₂ are real valued weights which are positive, but not strictly positive.

In step S6 the acceleration âₖ is finally calculated at the time tₖ by differentiating the parametric model, i.e.

$${\hat{a}}_{k} = \frac{d {s}_{k} ( {\hat{θ}}_{k} , )}{d t} {\vert}_{t = {t}_{k}} .$$

In a proposed embodiment with a motion model in the form of a second order polynomial is therefore \hat{α}ₖ=α₁.

In this embodiment the same time base is used for the resulting acceleration signal as for the original speed signal. To the skilled person it is obvious that the time base for the acceleration signal may be adjusted. The acceleration at an arbitrary time τ can be calculated according to

$$\hat{a} ( τ ) = \frac{d {s}_{k} ( {\hat{θ}}_{k} , )}{d t} {\vert}_{t = τ}$$

where k=argminₗ (abs(τ−tₗ)). In a proposed embodiment with a motion model in the form of a second order polynomial is therefore \hat{α}(τ)=α₁+2α₂(τ−tₖ) where k=argminₗ(abs(τ−tₗ)). Step S7 finishes the method.

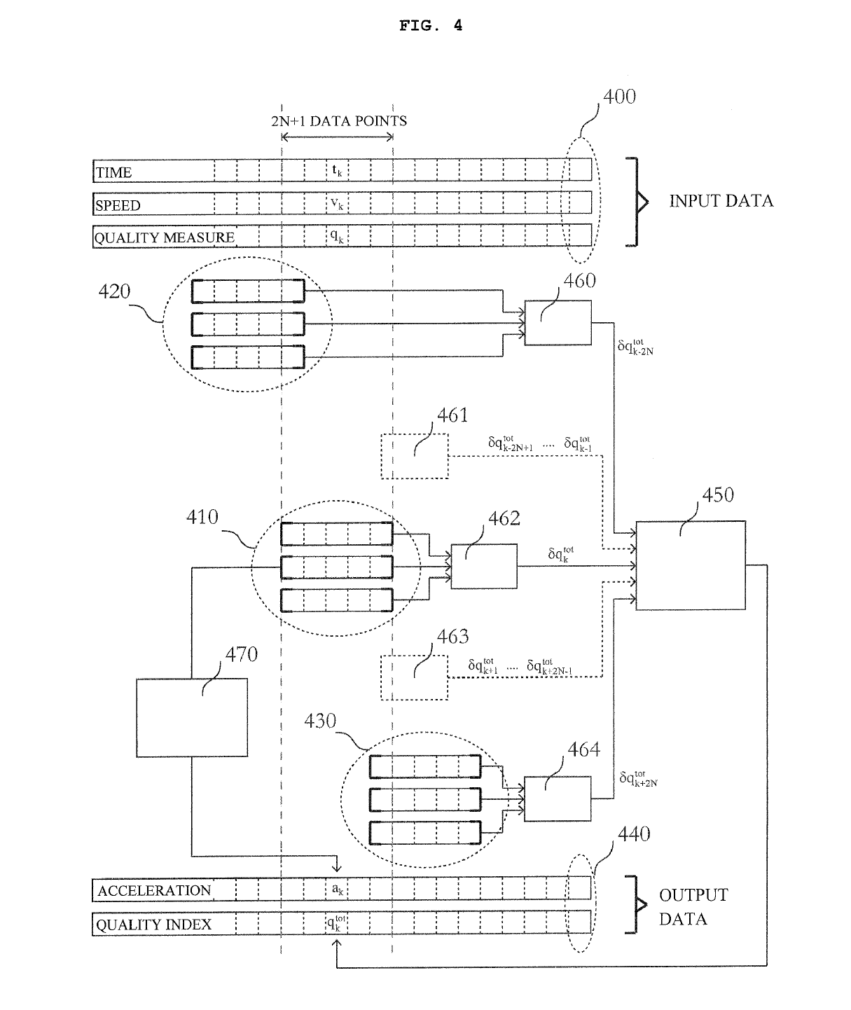

FIG. 4 shows a time chart for a proposed embodiment where 400 illustrates the stream of output data from an activated GNSS receiver, i.e. comprising times, speed values and quality measure. 410 illustrates a data block in accordance with FIG. 3. 420 illustrates an earlier data block compared to block 410 while 430 illustrates a later data block than 410. FIG. 4 illustrates data blocks of length 5 where the value of the acceleration in the center point is calculated, i.e. N=2 data points located symmetrically around the center point.

The calculated acceleration at time tₖ is calculated from data block 410 through means 470. The calculated quality index qₖ^{tot} at time tₖ, on the other hand is calculated as the sum of the quality measures of 420, 410, and 430 and (the in the figure not depicted) intermediate blocks corresponding to data blocks centered around the times t_{k-2N+1} . . . tₖ₋₁ and tₖ₊₁ . . . t_{k+2N-1} first through means 460, 462, and 464 (and corresponding not depicted means 461 and 463 corresponding to the data blocks centered around the times t_{k-2N+1} . . . tₖ₋₁ and tₖ₊₁ . . . t_{k+2N-1}) and in subsequent means 450. The means 460, 461, 462, 463 and 464, calculate partial quality indices {δq_{k-2N}^{tot}, . . . , δq_{k+2N}^{tot}}. Means 450 weights together the partial quality indices from said means 460, 461, 462, 463 and 464 to the final quality index qₖ^{tot}.

Weighting of the quality index qₖ^{tot} can be done in several ways. In a proposed design a direct summation is used, i.e. qₖ^{tot}=Σ_{l=k-2N}^{k+2N}δqₗ^{tot}. Other ways of weighting together comprise a weighted sum where the weight for the different partial quality indices is determined for example by the distance from the center point.

440 illustrates the stream of output data from the proposed embodiment of the invention, i.e. comprising acceleration signal and associated quality index. As the time chart indicates the processing of data is block based. In the proposed design in FIG. 4 an acceleration value is calculated at the time tₖ based on both future and historic measurement data from the GNSS receiver. It is obvious to the skilled person that such data processing implies a certain delay since future data first needs to be collected. In the example in FIG. 4 this means that acceleration value and quality index at time tₖ can be calculated only after data block centered around tₖ₊₄ has been collected, which in turn comprises data until and including the time tₖ₊₆. This means a built-in nominal delay in this example of 6 seconds, given that GNSS data is provided once per second. This is normally not a problem since the method is not primarily intended for real time processing of measurement data, but for post-processing after finished driving with the vehicle.

To the skilled person it is obvious that the built-in time delay, when needed, can be reduced by using a data block where tₖ is not centered in the block, for example by using only historic values.

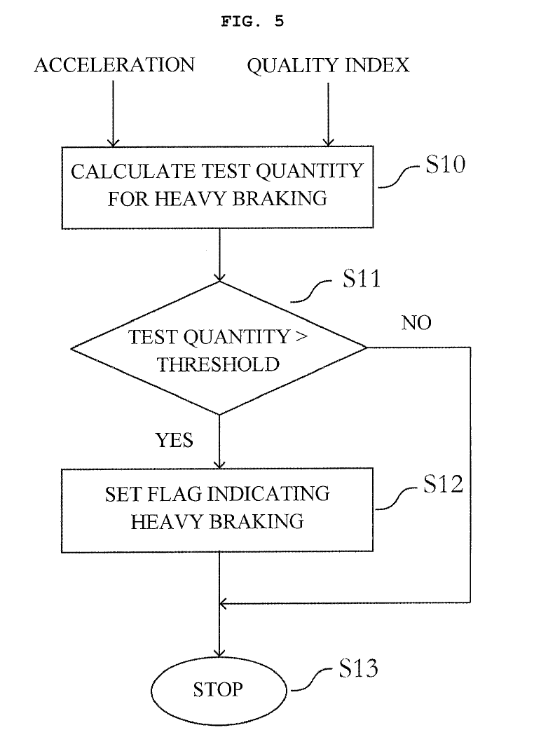

FIG. 5 shows a flow diagram for a method according to the proposed invention for detecting heavy braking. In step S10 a test quantity (TEST QUANTITY) is calculated from said acceleration values, or acceleration values and quality index.

Examples of test quantity comprise the ratio between the calculated acceleration and the calculated quality index. In a proposed embodiment of the embodiment is

$$TEST QUANTITY = \{ \begin{matrix}{\hat{a}}_{k} , {q}_{k}^{tot} < c \\ 0 , {q}_{k}^{tot} \geq c\end{matrix} ,$$

where c is a strictly positive real constant. In a proposed embodiment of the invention 0<c<10 is used.

In step S11 the in step S10 calculated test quantity TEST QUANTITY is compared with a threshold value (THRESHOLD); the threshold value may be constant, time varying, or data dependent. In a proposed embodiment a constant threshold value is used. A time varying threshold may in one embodiment depend on time of day, where a higher threshold is allowed during the daylight hours, controlled through a clock. A data dependent threshold value may be linked to the measured speed, where an increased speed may imply a different threshold level (higher or lower) compared to a lower speed.

If TEST QUANTITY is lower or equal to THRESHOLD the method finishes in step S13. If the test quantity is larger than the threshold value a flag (FLAG) is set in step S12 indicating heavy braking. FLAG indicates that heavy braking has occurred. In a proposed embodiment the number of set flags during a drive is stored. In a proposed embodiment the total number of set flags during a premium period for a car insurance is set, or other time period linked to a car insurance. In a proposed embodiment the times when the flag was set are stored.

The method finishes in step S13.

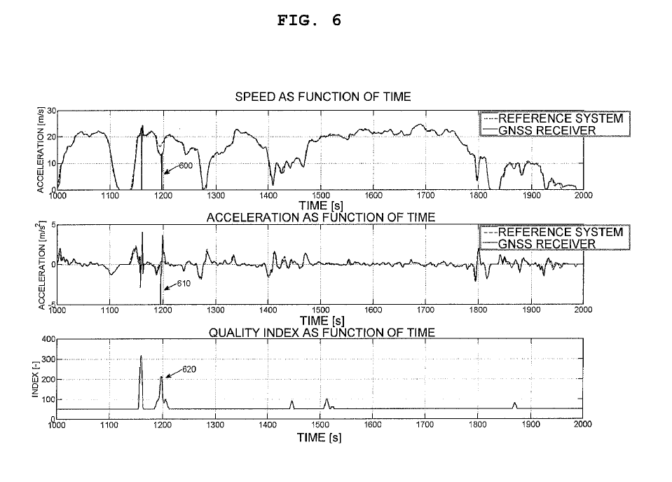

FIG. 6 shows an example of speed signal from a GNSS receiver built into a mobile phone when this is located in a car during travel (iPhone 5). From the figure it can be noted how the speed changes with time. A reference speed is picked up with equipment that does not have the deficiencies a speed signal form a GNSS receiver built into a mobile phone exhibits. The event 600 indicates a time when the GNSS receiver of the mobile phone presents an incorrect value. FIG. 6 also shows how the acceleration signal picked up through the reference equipment, and a resulting acceleration signal and quality index from a circuit diagram of an embodiment of signal processing in accordance with the invention. Since the speed signal from a GNSS receiver built into a mobile phone exhibits a large deviation compared to the reference signal at 600, also the resulting acceleration signal from a circuit diagram of an embodiment of signal processing in accordance with the invention exhibits a large deviation from the reference signal at 610. From quality index from a circuit diagram of an embodiment of signal processing in accordance with the invention a high index is noted at 620, indicating low reliability of the calculated acceleration signal.

An acceleration signal and quality index from a circuit diagram of an embodiment of signal processing in accordance with the invention thus enables more reliable detection of heavy braking of vehicles only using output data from a GNSS receiver, than when only the available speed signal from a GNSS receiver is used.

FIG. 7 shows an example of the distribution of sampling intervals for GNSS data from an iPhone 5.

The present invention may be implemented as a microprocessor, a digital signal processor (DSP), or a combination with corresponding software. In a design the method may be implemented as a computer program which is installed in a mobile phone or computer via computer-readable media such as CD, DVD, USB memory, hard drive, via AppStore or Android Market, etc. The steps of the method are then executed in this program.

Another possible implementation is to use programmable logic in FPGA (field programmable gate arrays) or ASIC (application specific integrated circuit).

The above described embodiments should be regarded as examples of the present invention. The skilled person realizes that different modifications, combinations and changes of the described embodiments may be done without diverting from the scope of the present invention. The scope of the present invention is however defined by the enclosed patent claims.

1. A method for calculation, with high time resolution, of acceleration of an object in motion from a measurement, with low time resolution, of speed of said object, wherein said method comprises
a. approximation of speed of said object from said speed measurement and a parametric model describing the motion of said object;
b. estimation of parameters in said parametric model through a parametric estimation method based on said speed measurement and said parametric model;
c. calculation of acceleration of said object from said parametric model and said estimated parameters,
and said method is further characterized by
d. calculation of a quality index representing the quality of said calculated acceleration from a quality measure representing the adaptation of said parametric model to said speed measurement, and a quality measure representing the quality of said speed measurement.

2. The method of claim 1, characterized in that said speed measurement is based on GNSS-measurements.

3. The method of claim 1, characterized in that said estimation of parameters in said parametric model is done by minimizing a cost function.

4. The method of claim 1, characterized in that said parametric model is a polynomial.

5. The method of claim 1, further characterized by
e. calculation of a test quantity based on said calculated acceleration;
f. comparison of said test quantity with a threshold value for determining a flag indicating heavy braking, wherein said method is used for detecting heavy braking of an object.

6. A signal processing device configured for calculation,
with high time resolution, of acceleration of an object in motion from a measurement, with low time resolution, of speed of said object, said signal processing device comprising a microprocessor, a digital signal processor, a field programmable gate array or an application specific integrated circuit, wherein said signal processing device is configured for
a. approximation of speed of said object from said speed measurement and a parametric model describing the motion of said object;
b. estimation of parameters in said parametric model through a parametric estimation method based on said speed measurement and said parametric model;
c. calculation of acceleration of said object from said parametric model and said estimated parameters,
and said signal processing device is further characterized by being configured for
d. calculation of a quality index representing the quality of said calculated acceleration from a quality measure representing the adaptation of said parametric model to said speed measurement, and a quality measure representing the quality of said speed measurement.

7. A computer program product for calculation, with high time resolution, of acceleration of an object in motion from a measurement, with low time resolution, of speed of said object, wherein said computer program product comprises
a. program element for approximation of speed of said object from said speed measurement and a parametric model describing the motion of said object;
b. program element for estimation of parameters in said parametric model through a parametric estimation method based on said speed measurement and said parametric model, wherein said estimation of parameters is done by minimizing a cost function;
c. program element for calculation of acceleration from said parametric model and said estimated parameters,
and said computer program product is further characterized by
d. program element for calculation of a quality index representing the quality of said calculated acceleration from a quality measure representing the adaptation of said parametric model to said speed measurement, and a quality measure representing the quality of said speed measurement, wherein said speed measurement is based on GNSS-measurements.

8. A computer program product according to claim 7, characterized in that said parametric model is a polynomial.

9. A computer program product according to claim 7, further characterized by
e. program element for calculation of a test quantity based on said calculated acceleration;
f. program element for comparison of said test quantity with a threshold value for determining a flag indicating heavy braking
wherein said computer program product is used for determining heavy braking of an object.
